(19) United States
(12) Patent Application Publication
(10) Pub. No.: US 2026/0028178 A1
(43) Pub. Date: Jan. 29, 2026

(54) WASTE RECEPTACLES

(71) Applicant: Sanvi Keskar, Delaware, OH (US)

(72) Inventor: Sanvi Keskar, Delaware, OH (US)

(21) Appl. No.: 19/276,279

(22) Filed: Jul. 22, 2025

Related U.S. Application Data
(60) Provisional application No. 63/675,422, filed on Jul. 25, 2024.

(51) Int. Cl. B65F 1/08; B65F 1/00; B65F 1/14; B65F 1/16

(52) U.S. Cl. CPC B65F 1/08; B65F 1/004; B65F 1/1473; B65F 1/16

(57) ABSTRACT

A waste receptacle includes a body and a grate. The body includes one or more sidewalls and one or more slats. The one or more sidewalls define a reuse bin chamber and a waste bin chamber, wherein the reuse bin chamber is sized to receive a reuse bin, and the waste bin chamber is sized to receive a waste bin. The one or more slats extending from the one or more sidewalls and disposed above the reuse bin chamber and the waste bin chamber. The grate is positioned above the waste bin chamber and extends from a lower edge to an upper edge, wherein the lower edge is coupled to the one or more slats, and the upper edge is coupled to the one or more sidewalls.

### CROSS-REFERENCE TO RELATED APPLICATION

The present disclosure claims the priority benefit of U.S. Provisional Patent Application Ser. No. 63/675,422, entitled “WASTE RECEPTACLES” and filed Jul. 25, 2024, the entire contents of which is incorporated by reference herein.

### TECHNICAL FIELD

The present specification generally relates to waste receptacles and, more specifically, waste receptacles configured to sort waste from reusable materials.

### BACKGROUND

Reusing and recycling reusable materials such as recyclable plastic containers, reusable dishware, and the like is generally more sustainable and environmentally friendly than discarding such reusable materials after a single use. In order to reuse or recycle material, that reusable material must be separated from waste material, which cannot be reused or recycled. This sorting is often accomplished by encouraging individuals to personally sort reusable materials into a recycling receptacle and waste materials into a waste receptacle. Due to the increased effort on the part of the individuals (e.g., locating the appropriate receptacles and correctly sorting material as reusable or waste), the sorting of materials may be completed in error or avoided entirely. Lack of separation or improper separation of reusable materials and recyclable materials from waste material may increase levels of waste. Accordingly, it may be beneficial to decrease the effort on the part of the individual required to properly sort reusable material from waste material.

### SUMMARY

According to a first aspect A1, a waste receptacle comprising a body and a grate, the body comprising one or more sidewalls defining a reuse bin chamber and a waste bin chamber, wherein the reuse bin chamber is sized to receive a reuse bin, and the waste bin chamber is sized to receive a waste bin; and one or more slats extending from the one or more sidewalls and disposed above the reuse bin chamber and the waste bin chamber, wherein the grate is positioned above the waste bin chamber and extends from a lower edge to an upper edge, wherein the lower edge is coupled to the one or more slats, and the upper edge is coupled to the one or more sidewalls.

A second aspect A2 includes the waste receptacle of the first aspect A1, further comprising one or more pockets, the pockets removably attachable to one or more sidewalls.

A third aspect A3 includes the waste receptacle of the first aspect A1, wherein the body comprises a lid, the waste bin comprises a lid, and the reuse bin comprises a lid.

A fourth aspect A4 includes the waste receptacle of the first aspect A1, wherein the upper edge comprises a lip, wherein the lip is removably attached to top surface of one of the one or more sidewalls.

A fifth aspect A5 includes the waste receptacle of the first aspect A1, further comprising a standoff, wherein the standoff is removably insertable between a top edge of the grate and the one or more sidewalls, and the standoff is adjustable at an angle of the grate from 10 to 85 degrees.

A sixth aspect A6 includes the waste receptacle of the first aspect A1, wherein the standoff further comprises a first hook at a first end and a second hook at a second end opposite the first end, wherein the second hook fits against the top surface of the one or more sidewalls and the first hook fits against the grate.

A seventh aspect A7 includes the waste receptacle of the first aspect A1, wherein the lower edge comprises an extension, the one or more slats comprises an extension slot, and the lower edge is removably coupled to the one or more slats by inserting the lower edge extension into the extension slot of the one or more slats.

An eighth aspect A8 includes the waste receptacle of the first aspect A1, wherein the one or more slats is formed with the body or attached thereto using weld, adhesive, screws, rivets, or combinations thereof.

A ninth aspect A9 includes the waste receptacle of the first aspect A1, wherein the body comprises one or more wheels disposed on a bottom surface of the body, the waste bin further comprises one or more wheels disposed on a bottom surface of the waste bin; and the reuse bin further comprises one or more wheels disposed on a bottom surface of the reuse bin.

A tenth aspect A10 includes the waste receptacle of the ninth aspect A9, wherein the one or more wheels further comprise a wheel lock, the wheel lock moveable between a locked arrangement and an unlocked arrangement.

An eleventh aspect A11 includes the waste receptacle of the first aspect A1, wherein the reuse bin chamber and the waste bin chamber are spaced apart by a divider and the divider is substantially parallel to one or more of the one or more sidewalls.

A twelfth aspect A12 includes the waste receptacle of the eleventh aspect A11, wherein the divider extends between the third sidewall and the fourth sidewall.

A thirteenth aspect A13 includes the waste receptacle of the eleventh aspect A11, wherein the divider extends to the third sidewall and to the fourth sidewall.

A fourteenth aspect A14 includes the waste receptacle of the first aspect A1, wherein the grate comprises one or more apertures

A fifteenth aspect A15 includes the waste receptacle of the fourteenth aspect A14, wherein the apertures have a shape resembling a square, a rectangle, a circle, an ellipse, any regular shape, any irregular shape, or combinations thereof.

A sixteenth aspect A16 includes the waste receptacle of the fourteenth aspect A14, includes the waste receptacle of the fourteenth aspect A14, wherein the area of each of the one or more apertures is from 1 square inch to 8 square inch.

A seventeenth aspect A17 includes the waste receptacle of the first aspect A1, wherein the one or more sidewalls are perpendicular to a floor, the one or more sidewalls comprising a first sidewall, a second sidewall spaced apart from the first sidewall, a third sidewall extending between the first sidewall and the second sidewall, and a fourth sidewall extending between the first sidewall and the second sidewall and opposite the third sidewall, the one or more slats comprises a first slat and a second slat, each of the first slat and the second slat comprising a first elongated portion and a second elongated portion wherein the first slat extends from the third sidewall at a downward angle and the second slat extends from the fourth sidewall at a downward angle, and the grate is from 10 to 85 degrees relative to the floor.

A eighteenth aspect A18 includes the waste receptacle of the first aspect A1, wherein the waste receptacle is circular in shape, and from 10 in to 100 in in diameter.

An nineteenth aspect A19 includes the waste receptacle of the first aspect A1, further comprising an auxiliary bin coupled to the one or more sidewalls wherein the auxiliary bin comprises a body defining a pocket of from 9 cubic inches to 6500 cubic inches volume.

A twentieth aspect A20 includes the waste receptacle of the eighteenth aspect A18, wherein the auxiliary bin is removably coupled to the one or more sidewalls.

A twenty-first aspect A21 includes the waste receptacle of the first aspect A1, further comprising one or more openings on the one or more sidewalls, to which a reuse bin or a waste bin may be passed through.

A twenty-second aspect A22 includes the waste receptacle of the twentieth aspect, further comprising one or more chamber doors.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a front perspective view of a waste receptacle, according to one or more embodiments shown and described herein;

FIG. 2 schematically depicts a top perspective view of the waste receptacle of FIG. 1, according to one or more embodiments shown and described herein;

FIG. 3 schematically depicts another top perspective view of the waste receptacle of FIG. 1 showing the grate raised by a standoff, according to one or more embodiments shown and described herein;

FIG. 4 schematically depicts a top perspective view of another embodiment of a waste receptacle, according to one or more embodiments shown and described herein;

FIG. 5 schematically depicts a front perspective view of yet another embodiment of a waste receptacle, according to one or more embodiments shown and described herein; and

FIG. 6 schematically depicts a top perspective view of yet another embodiment of a waste receptacle, according to one or more embodiments shown and described herein.

### DETAILED DESCRIPTION

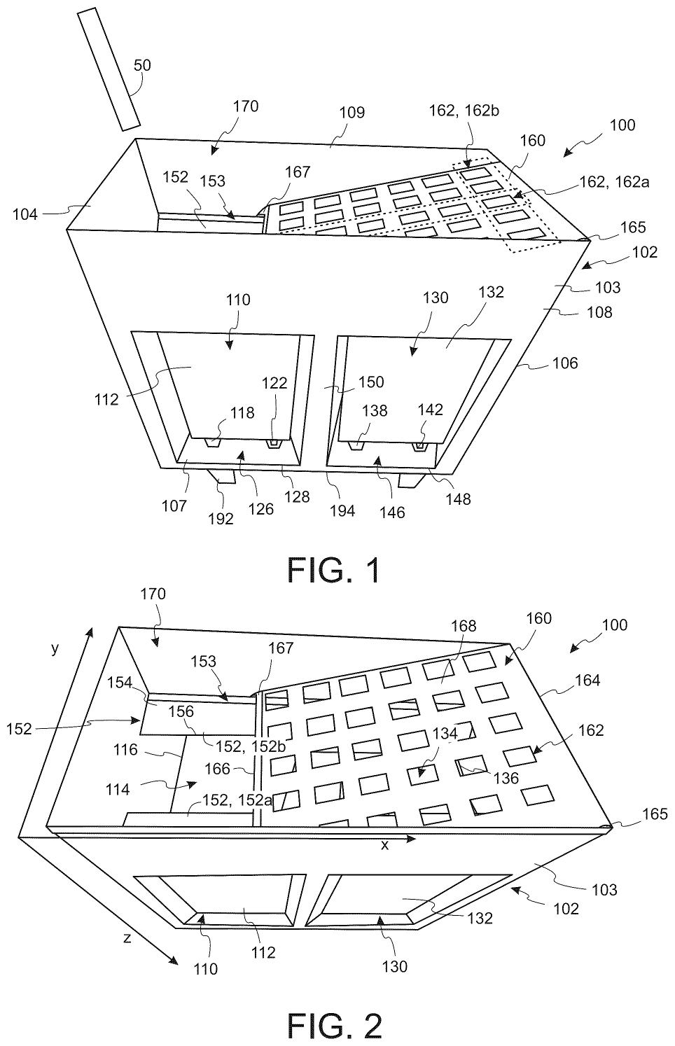

FIGS. 1 and 2 schematically depict a waste receptacle that includes a body and a grate. The body includes one or more sidewalls and one or more slats. The one or more sidewalls define a reuse bin chamber and a waste bin chamber, wherein the reuse bin chamber is sized to receive a reuse bin, and the waste bin chamber is sized to receive a waste bin. The one or more slats extending from the one or more sidewalls and disposed above the reuse bin chamber and the waste bin chamber. The grate is positioned above the waste bin chamber and extends from a lower edge to an upper edge, wherein the lower edge is coupled to the one or more slats, and the upper edge is coupled to the one or more sidewalls. When a combination of waste material and reuse material is placed on the grate, the waste receptacle may separate the waste material from the reuse material, thereby decreasing the effort on the part of an individual required to sort reusable material from waste material.

Reference will now be made in detail to various embodiments of a waste receptacle. According to some embodiments, a waste receptacle may include a body and a grate. According to some embodiments, the body may include one or more sidewalls defining a reuse bin chamber and a waste bin chamber. According to some embodiments, the reuse bin chamber may be sized to receive a reuse bin, and the waste bin chamber may be sized to receive a waste bin; and one or more slats may extend from the one or more sidewalls and may be disposed above the reuse bin chamber and the waste bin chamber. According to some embodiments, the grate may be positioned above the waste bin chamber and extend from a lower edge to an upper edge, where the lower edge may be coupled to the one or more slats, and the upper edge is coupled to the one or more sidewalls.

Various embodiments of waste receptacles will be described herein with specific reference to the appended drawings.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and the number or type of embodiments described in the specification.

Directional terms as used herein—for example up, down, right, left, front, back, top, bottom—are made only with reference to the figures as drawn and are not intended to imply absolute orientation.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, “reusable material” or “reuse material” refers collectively to material that may be recycled (e.g. processed and converted into a new, usable material or object) and to material that may be reused (e.g. cleaned and reused in the material's current form).

Referring now to FIG. 1, a waste receptacle 100 is schematically depicted. The waste receptacle 100 may include a reuse bin 110 and a waste bin 130 housed within a body 102.

The body 102 may include one or more sidewalls 103 including a first sidewall 104, a second sidewall 106 spaced apart from the first sidewall 104, a third sidewall 108 extending between the first sidewall 104 and the second sidewall 106, and a fourth sidewall 109 extending between the first sidewall 104 and the second sidewall 106 and opposite the third sidewall 108. Each of the one or more sidewall 103 may extend vertically from a floor 107.

The one or more sidewalls 103 may define a reuse bin chamber 126 and a waste bin chamber 146. More specifically, the reuse bin chamber 126 and the waste bin chamber 146 may be disposed between the first sidewall 104 and the second sidewall 106. The reuse bin chamber 126 may be sized to receive the reuse bin 110 therein, and the waste bin chamber 146 may be sized to receive the waste bin 130 therein. Each of the reuse bin chamber 126 and the waste bin chamber 146 may include a front opening 128, 148 extending through the third sidewall 108 of the body 102 of the waste receptacle 100. The front openings 128, 148 may enable insertion of the reuse bin 110 and the waste bin 130 into the reuse bin chamber 126 and waste bin chamber 146, respectively.

In some embodiments, the reuse bin chamber 126 and the waste bin chamber 146 may be further defined and spaced apart by a divider 150. The divider 150 may extend vertically from the floor 107 of the body 102. In some embodiments, the divider 150 may be substantially parallel to the first sidewall 104 and/or the second sidewall 106. In some embodiments, the divider 150 may extend from the third sidewall 108 to the fourth sidewall 109. In other embodiments, the divider 150 may be separated from the fourth sidewall 109. In some such embodiments, the divider 150 may not extend past the third sidewall 108 and may be aligned with the third sidewall 108, such as depicted.

The body 102 of the waste receptacle 100 may have a top opening 170. The top opening 170 may provide access to the reuse bin chamber 126 and the waste bin chamber 146 from above. The top opening 170 may or may not include a lid 50. Accordingly, material may be deposited into the reuse bin 110 and the waste bin 130 via the top opening 170 of the waste receptacle 100 when the reuse bin 110 and the waste bin 130 are positioned within the reuse bin chamber 126 and the waste bin chamber 146, respectively. The waste receptacle 100 may be generally shaped as a rectangular prism, such as depicted; however, other shapes are contemplated and possible. For example, the waste receptacle 100 may be shaped as a cylinder, a polyhedron, or any other shape suitable for receiving material therein. The body 102 of the waste receptacle 100 may be generally shaped as a rectangular prism, such as depicted; however, other shapes are contemplated and possible. For example, the body 102 of the waste receptacle 100 may be shaped as a cylinder, a polyhedron, or any other shape suitable for receiving material therein.

With reference to FIG. 2, the reuse bin 110 may include a reuse body 112 defining a reuse inner volume 114 therein. The reuse body 112 may be generally shaped as a rectangular prism, such as depicted; however, other shapes are contemplated and possible. For example, the reuse body 112 may be shaped as a cylinder, a polyhedron, or any other shape suitable for receiving material therein. The reuse body 112 may have a top opening 116 enabling access to the reuse inner volume 114. Accordingly, as will be described in greater detail herein, reusable material may be positioned within the reuse inner volume 114 via the top opening 116.

In some embodiments, the reuse bin 110 may include one or more wheels 118 disposed on a bottom surface of the reuse bin 110, as shown in FIG. 1. The one or more wheels 118 may facilitate movement of the reuse bin 110 and, in particular, may facilitate movement of the reuse bin 110 into and out of the body 102 of the waste receptacle 100. The one or more wheels 118 may be lockable via a wheel lock 122 which may be moveable between a locked arrangement and an unlocked arrangement. When the wheel lock 122 is in the unlocked arrangement, the one or more wheels 118 may be rotatable, thereby facilitating movement of the reuse bin 110. When the wheel lock 122 is in the locked arrangement, the one or more wheels 118 may be fixed, or nonrotatable, thereby hindering movement of the reuse bin 110. In some embodiments, the wheel lock 122 may be generally kept in the locked arrangement while the reuse bin 110 is positioned within the body 102. This may prevent inadvertent removal of the reuse bin 110. The wheel lock 122 may then be moved to the unlocked configuration when removal of the reuse bin 110 from the body 102 is desired. Removal of the reuse bin 110 may be desired, for example, for cleaning of the reuse bin 110 and/or for transport of the reuse materials stored within the reuse bin 110.

The waste bin 130 may include a waste body 132 defining a waste inner volume 134 therein, as shown in FIG. 2. The waste body 132 may be shaped as a rectangular prism, such as depicted; however, other shapes are contemplated and possible. For example, the waste body 132 may be shaped as a cylinder, a polyhedron, or any other shape suitable for receiving material therein. As depicted, the waste body 132 may have substantially the same shape as the reuse body 112. However, in some embodiments the shapes of the waste body 132 and the reuse body 112 may differ. In some embodiments, the sizes of the waste body 132 and the reuse body 112 may differ. For example, if the waste receptacle 100 is expected to receive a greater amount of waste material than reuse material, then the waste body 132 may be sized larger than the reuse body 112. The waste bin chamber 146 may, accordingly, be sized larger than the reuse bin chamber 126. The waste body 132 may have a top opening 136 enabling access to the waste inner volume 134. Accordingly, as will be described in greater detail herein, waste material may be positioned within the waste inner volume 134 via the top opening 136.

In some embodiments, the waste bin 130 may include one or more wheels 138 disposed on a bottom surface of the waste bin 130, as shown in FIG. 1. The one or more wheels 138 may facilitate movement of the waste bin 130 and, in particular, may facilitate movement of the waste bin 130 into and out of the body 102 of the waste receptacle 100. The one or more wheels 138 may be lockable via a wheel lock 142 which may be moveable between a locked arrangement and an unlocked arrangement. When the wheel lock 142 is in the unlocked arrangement, the one or more wheels 138 may be rotatable, thereby facilitating movement of the waste bin 130. When the wheel lock 144 is in the locked arrangement, the one or more wheels 138 may be fixed, or nonrotatable, thereby hindering movement of the waste bin 130. In some embodiments, the wheel lock 142 may be generally kept in the locked arrangement while the waste bin 130 is positioned within the body 102. This may prevent inadvertent removal of the waste bin 130. The wheel lock 122 may then be moved to the unlocked configuration when removal of the waste bin 130 from the body 102 is desired. Removal of the waste bin 130 may be desired, for example, for cleaning of the waste bin 130 and/or for transport of the waste materials stored within the waste bin 130.

Still referring to FIG. 1, in some embodiments, the waste receptacle 100 may have one or more wheels 192 disposed on a bottom surface 194 of the body 102. The one or more wheels 192 may be lockable via a wheel lock which may be moveable between a locked arrangement and an unlocked arrangement such as described with respect to the wheel locks 122 and 142.

Referring to FIGS. 1 and 2 in combination, in some embodiments, the body 102 of the waste receptacle 100 may include one or more slats 152 including a first slat 152a and a second slat 152b. Each of the one or more slats 152 may have a first elongated portion 154 and a second elongated portion 156. The first elongated portion 154 may be coupled to the one or more sidewalls 103. The second elongated portion 156 may be cantilevered from the one or more sidewalls and positioned vertically lower than the first elongated portion 154. In other words, each of the one or more slats 152 may extend from the one or more sidewalls 103 at a downward angle. Referring now to FIG. 2, each of the one or more slats 152 may extend from the one or more sidewalls 103 at a downward angle in the z-direction as defined by the coordinate axis. In particular, the first slat 152a may extend from the third sidewall 108 at a downward angle and the second slat 152b may extend from the fourth sidewall 109 at a downward angle. This may create a funnel-like geometry such that any material that contacts the one or more slats 152 may slide downward off of the one or more slats 152 and into the reuse bin 110 or the waste bin 130.

Although the one or more slats 152 is depicted as having two slats, a greater number of slats is contemplated and possible. For example, in some embodiments, the one or more slats may include a third slat and a fourth slat which may be coupled to the first sidewall and the second sidewall, respectively. The one or more slats 152 may be integrally formed with the body 102 or may be attached thereto using weld, adhesive, screws, rivets, or other attachment means. In some embodiments, the one or more slats 152 may extend from the sidewalls 103 at a downward angle such that the distance from the sidewall to the end of the slat distal to the side wall 103 is less than or equal to 50% of the length of the adjacent side wall 103. In embodiments the end of the one or more slats 150 distal to the side wall 103 is above the waste bin. In embodiments, the angle of the one or more slat relative to the x-y plane as defined by coordinate system of FIG. 2, may be from 10° to 85°. For example, the angle of the one or more slats 152 may be from 10° to 85°, from 10° to 78°, from 10° to 70°, from 10° to 63°, from 10° to 55°, from 10° to 48°, from 10° to 40°, from 10° to 33°, from 10° to 25°, from 10° to 18°, from 18° to 85°, from 18° to 78°, from 18° to 70°, from 18° to 63°, from 18° to 55°, from 18° to 48°, from 18° to 40°, from 18° to 33°, from 18° to 25°, from 25° to 85°, from 25° to 78°, from 25° to 70°, from 25° to 63°, from 25° to 55°, from 25° to 48°, from 25° to 40°, from 25° to 33°, from 33° to 85°, from 33° to 78°, from 33° to 70°, from 33° to 63°, from 33° to 55°, from 33° to 48°, from 33° to 40°, from 40° to 85°, from 40° to 78°, from 40° to 70°, from 40° to 63°, from 40° to 55°, from 40° to 48°, from 48° to 85°, from 48° to 78°, from 48° to 70°, from 48° to 63°, from 48° to 55°, from 55° to 85°, from 55° to 78°, from 55° to 70°, from 55° to 63°, from 63° to 85°, from 63° to 78°, from 63° to 70°, from 70° to 85°, from 70° to 78°, or from 78° to 85°. Angle is sufficient to promote movement across slats into the bins.

Disposed within the top opening 170 of the waste receptacle 100 may be a grate 160. The grate 160 may extend from an upper edge 164 to a lower edge 166 and may be positioned generally above the waste bin 130 and the recycle bin 110. As depicted, the grate 160 may be configured as a generally flat plate having a rectangular shape; however, other shapes are contemplated and possible. The grate 160 may define one or more apertures 162 extending therethrough and disposed between the upper edge 164 and the lower edge 166. The one or more apertures 162 extends generally in a vertical direction such that the one or more apertures 162 open into the waste receptacle 100. In some embodiments, the one or more apertures 162 may have substantially the same size and shape. In other embodiments, the size and shape may vary. As depicted, the one or more apertures 162 may have a substantially square shape. In other embodiments, the one or more apertures 162 may have a rectangular shape, circular shape, or any regular or irregular shape. Each of the one or more apertures 162 may be sized large enough to allow waste material, such as food and napkins, to pass through the one or more apertures 162. The one or more apertures 162 may be sized small enough to prevent reuse material, such as plates and bowls, from passing through the one or more apertures 162. For example, in some embodiments, each of the one or more apertures 162 may have an effective area between 5 cm² (about 1 in²) and 52 cm² (about 8 in²). However, smaller and larger sizes of the one or more apertures 162 are contemplated and possible. In embodiments, the size of each of the one or more apertures may be from 5 cm² to 52 cm², from 5 cm² to 47 cm², from 5 cm² to 43 cm², from 5 cm² to 38 cm², from 5 cm² to 33 cm², from 5 cm² to 29 cm², from 5 cm² to 24 cm², from 5 cm² to 19 cm², from 5 cm² to 14 cm², from 5 cm² to 10 cm², from 10 cm² to 52 cm², from 10 cm² to 47 cm², from 10 cm² to 43 cm², from 10 cm² to 38 cm², from 10 cm² to 33 cm², from 10 cm² to 29 cm², from 10 cm² to 24 cm², from 10 cm² to 19 cm², from 10 cm² to 14 cm², from 14 cm² to 52 cm², from 14 cm² to 47 cm², from 14 cm² to 43 cm², from 14 cm² to 38 cm², from 14 cm² to 33 cm², from 14 cm² to 29 cm², from 14 cm² to 24 cm², from 14 cm² to 19 cm², from 19 cm² to 52 cm², from 19 cm² to 47 cm², from 19 cm² to 43 cm², from 19 cm² to 38 cm², from 19 cm² to 33 cm², from 19 cm² to 29 cm², from 19 cm² to 24 cm², from 24 cm² to 52 cm², from 24 cm² to 47 cm², from 24 cm² to 43 cm², from 24 cm² to 38 cm², from 24 cm² to 33 cm², from 24 cm² to 29 cm², from 29 cm² to 52 cm², from 29 cm² to 47 cm², from 29 cm² to 43 cm², from 29 cm² to 38 cm², from 29 cm² to 33 cm², from 33 cm² to 52 cm², from 33 cm² to 47 cm², from 33 cm² to 43 cm², from 33 cm² to 38 cm², from 38 cm² to 52 cm², from 38 cm² to 47 cm², from 38 cm² to 43 cm², from 43 cm² to 52 cm², from 43 cm² to 47 cm², or from 47 cm² to 52 cm²,

In some embodiments, the one or more apertures 162 may be arranged in a repeating pattern. For example, as depicted, the one or more apertures 162 may be arranged in a grid pattern having rows 162a and columns 162b (schematically depicted with hashes in FIG. 1). In other embodiments, the one or more apertures 162 may be arranged in a brick-like pattern including the rows 162a wherein each of the rows 162a is offset from each neighboring row 162a. Similarly, in some embodiments, the one or more apertures 162 may be arranged in a brick-like pattern including the columns 162b, wherein each of the columns 162b is offset from each neighboring column 162b.

With reference to FIG. 2, the grate 160 may include edges 168 which may define and separate the one or more apertures 162. The edges 168 may be sized such that one or more apertures 162 make up the majority of the surface area of the grate 160 and the edges 168 make up the minority of the surface area of the grate 160. As depicted, in some embodiments, the edges 168 may have a characteristic thickness of about 12.7 mm (about 0.5 in). However, other embodiments may include thicker or thinner edges 168. For example, in some embodiments, the edges 168 may have a wire-like geometry. In embodiments, the edges may have a thickness of from 0.01 mm to 13 mm. For instance, the edges may have a thickness of from 0.01 mm to 13 mm, from 0.01 mm to 11 mm, from 0.01 mm to 9 mm, from 0.01 mm to 7 mm, from 0.01 mm to 6 mm, from 0.01 mm to 4 mm, from 0.01 mm to 2 mm, from 2 mm to 13 mm, from 2 mm to 11 mm, from 2 mm to 9 mm, from 2 mm to 7 mm, from 2 mm to 6 mm, from 2 mm to 4 mm, from 4 mm to 13 mm, from 4 mm to 11 mm, from 4 mm to 9 mm, from 4 mm to 7 mm, from 4 mm to 6 mm, from 5.5 mm to 13 mm, from 5.5 mm to 11 mm, from 5.5 mm to 9 mm, from 5.5 mm to 7 mm, from 7.5 mm to 13 mm, from 7.5 mm to 11 mm, from 7.5 mm to 9 mm, from 9.5 mm to 13 mm, from 9.5 mm to 11 mm, or from 11 mm to 13 mm.

As depicted, the upper edge 164 of the grate 160 may be coupled to the second sidewall 106 of the waste receptacle 100. The lower edge 166 may be coupled to the body 102 of the waste receptacle 100 at a location that is vertically lower than the upper edge 164. Accordingly, grate 160 may be arranged at a downward angle with respect to the x-y plane as defined by the coordinate axis. As will be described in greater detail herein, the downward angle of the grate 160 with respect to the x-y plane as defined by the coordinate axis may facilitate sorting reuse material into the reuse bin 110.

As stated, the upper edge 164 of the grate 160 may be coupled to the second sidewall 106 of the waste receptacle 100. In particular, as depicted in FIGS. 1 and 2, the upper edge 164 may include a lip 165 which may fit against the top surface of the second sidewall 106. Accordingly, the upper edge 164 may be removably coupled to the second sidewall 106. This may be beneficial in some embodiments as it may allow removal of the grate 160 from the body 102 of the waste receptacle 100 for cleaning, accessing the interior of the waste bin chamber, and the like.

In other embodiments, the upper edge 164 may be nonremovably coupled to the second sidewall 106, such as with weld, adhesive, screws, rivets, or other attachment means. In some embodiments, the upper edge 164 may be nonremovably coupled to the divider 150 with a hinge (not depicted). This may enable rotational movement of the grate 160 such that the grate 160 may be rotated away from the waste bin chamber 146 and toward an exterior of the body 102. Such rotation may allow increased access to the waste bin chamber 146.

As depicted in FIG. 2, the lower edge 166 may be coupled to the one or more slats 152. In particular, the lower edge 166 may have an extension 167 which may be insertable into a corresponding slot 153 of the one or more slats 152. Accordingly, the lower edge 166 may be removably coupled to the one or more slats 152. This may be beneficial in some embodiments as it may allow removal of the grate 160 from the body 102 of the waste receptacle 100 for cleaning, accessing the interior of the waste bin chamber, and the like.

As will now be appreciated, in light of FIGS. 1-2, the waste receptacle 100 may be operable to sort waste material from reuse material. In particular, a user wishing to discard a combination of reuse material and waste material (such as a recyclable paper plate laden with food scraps) may place the combination onto the grate 160 of the waste receptacle 100 proximate the upper edge 164 such that the waste material directly contacts the grate 160 (e.g. the plate laden with food scraps may be positioned facing downward such that the food scraps are oriented beneath the plate and in contact with the grate 160). The user may then release the combination. The waste material (e.g. the food scraps) may then fall through the one or more apertures 162 of the grate 160 and into the waste bin 130. The reuse material (e.g. the plate) may slide down the downward slope of the grate 160 from the upper edge 164 to the lower edge 166 and into the reuse bin 110. Accordingly, the waste material may be sorted into the waste bin 130, and the reuse material may be sorted into the reuse bin 110. In this way, the waste receptacle 100 may sort waste material from reuse material.

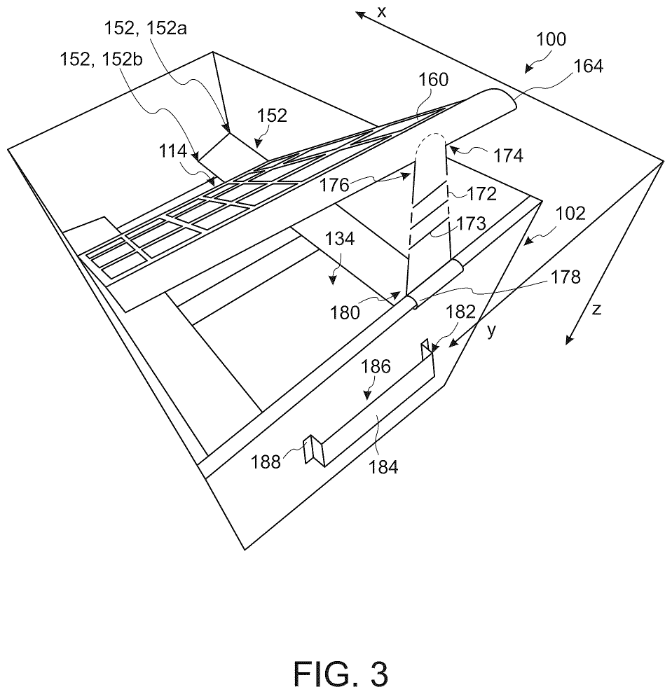

Referring now to FIG. 3, in some embodiments, the waste receptacle 100 may include a standoff 172. The standoff 172 may be removable and may be insertable between the upper edge 164 of the grate 160 and the second sidewall 106. Accordingly, the standoff 172 may be operable to adjust the angle of the grate 160. This may be beneficial in some embodiments as a larger downward angle of the grate 160 with respect to the x-y plane as defined by the coordinate axis may enable easier and faster transfer of reuse materials down the slope of the grate 160 and into the reuse bin 110. In embodiments, the downward angle of the grate 160 with respect to the x-y plane as defined by the coordinate axis may be from 10° to 85°. For instance, the downward angle of the grate 160 with respect to the x-y plane as defined by the coordinate axis may be from 10° to 85°, from 10° to 74°, from 10° to 64°, from 10° to 53°, from 10° to 42°, from 10° to 31°, from 10° to 21°, from 21° to 85°, from 21° to 74°, from 21° to 64°, from 21° to 53°, from 21° to 42°, from 21° to 31°, from 31° to 85°, from 31° to 74°, from 31° to 64°, from 31° to 53°, from 31° to 42°, from 42° to 85°, from 42° to 74°, from 42° to 64°, from 42° to 53°, from 53° to 85°, from 53° to 74°, from 53° to 64°, from 64° to 85°, from 64° to 74°, or from 74° to 85°. In embodiments, the width of the standoff may be the same as the width of the sidewall to which the standoff is removably attached. In embodiments, the length of the standoff may be adjustable such that the downward angle of the grate with respect to the x-y plane as defined by the coordinate axis may reach a desired angle. Though the standoff is shown as extending along a portion of the one or more sidewalls in the x-direction according to the coordinate system, it is to be appreciated that the standoff may be extended to any portion along the sidewall including the entire sidewall. If the angle is too small, reusable material may not enter the reuse bin. If the angle is too large, the waste material may not filter through the grates as desired.

As depicted in FIG. 3, the standoff 172 may have a first hook 174 at a first end 176 and a second hook 178 at a second end 180 opposite the first end 176. The first hook 174 may be sized to fit against the upper edge 164 of the grate 160. The second hook 178 may be sized to fit against the top surface of the second sidewall 106. Accordingly, when the standoff 172 is inserted between the upper edge 164 of the grate 160 and the second sidewall 106, the first hook 174 may retain the standoff 172 in place relative to the grate 160, and the second hook 178 may retain the standoff 172 in place relative to the second sidewall 106. In this way, the relative positions of the standoff 172, the grate 160, and the second sidewall 106 may be fixed, and the grate 160 may be supported at a steeper downward angle with respect to the x-y plane as defined by the coordinate axis. In some embodiments, the length of the standoff may be adjustable. In some embodiments, the standoff 172 may include adjustable notches 173 removably attachable to the first hook 174 to adjust the height.

The waste receptacle 100 may include an auxiliary bin 182 coupled to the one or more sidewalls 103. The auxiliary bin 182 may include a body 184 defining a pocket 186 sized and shaped to receive utensils or other reuse materials therein. In some embodiments, the auxiliary bin 182 may include one or more tabs 188 extending from the body 184. The one or more tabs 188 may be receivable into a slot positioned on an exterior of the one or more sidewalls 103. Accordingly, the auxiliary bin 182 may be removably coupled to the one or more sidewalls 103. As depicted in FIG. 3, the auxiliary bin 182 may be coupled to the second sidewall 106. However, in other embodiments, the auxiliary bin 182 may be coupled to another sidewall such as the first sidewall 104. In some embodiments, the auxiliary bin 182 may be nonremovably coupled to the one or more sidewalls 103, such as with weld, adhesive, screws, rivets, or other attachment means.

In embodiments, the volume of the auxiliary bin 182 may be from 9 cubic inches to 6500 cubic inches. For example, the volume of the auxiliary bin 182 may be from 9 cubic inches to 6500 cubic inches, from 9 cubic inches to 5689 cubic inches, from 9 cubic inches to 4877 cubic inches, from 9 cubic inches to 4066 cubic inches, from 9 cubic inches to 3255 cubic inches, from 9 cubic inches to 2443 cubic inches, from 9 cubic inches to 1632 cubic inches, from 9 cubic inches to 820 cubic inches, from 820 cubic inches to 6500 cubic inches, from 820 cubic inches to 5689 cubic inches, from 820 cubic inches to 4877 cubic inches, from 820 cubic inches to 4066 cubic inches, from 820 cubic inches to 3255 cubic inches, from 820 cubic inches to 2443 cubic inches, from 820 cubic inches to 1632 cubic inches, from 1632 cubic inches to 6500 cubic inches, from 1632 cubic inches to 5689 cubic inches, from 1632 cubic inches to 4877 cubic inches, from 1632 cubic inches to 4066 cubic inches, from 1632 cubic inches to 3255 cubic inches, from 1632 cubic inches to 2443 cubic inches, from 2443 cubic inches to 6500 cubic inches, from 2443 cubic inches to 5689 cubic inches, from 2443 cubic inches to 4877 cubic inches, from 2443 cubic inches to 4066 cubic inches, from 2443 cubic inches to 3255 cubic inches, from 3255 cubic inches to 6500 cubic inches, from 3255 cubic inches to 5689 cubic inches, from 3255 cubic inches to 4877 cubic inches, from 3255 cubic inches to 4066 cubic inches, from 4066 cubic inches to 6500 cubic inches, from 4066 cubic inches to 5689 cubic inches, from 4066 cubic inches to 4877 cubic inches, from 4877 cubic inches to 6500 cubic inches, from 4877 cubic inches to 5689 cubic inches, or from 5689 cubic inches to 6500 cubic inches.

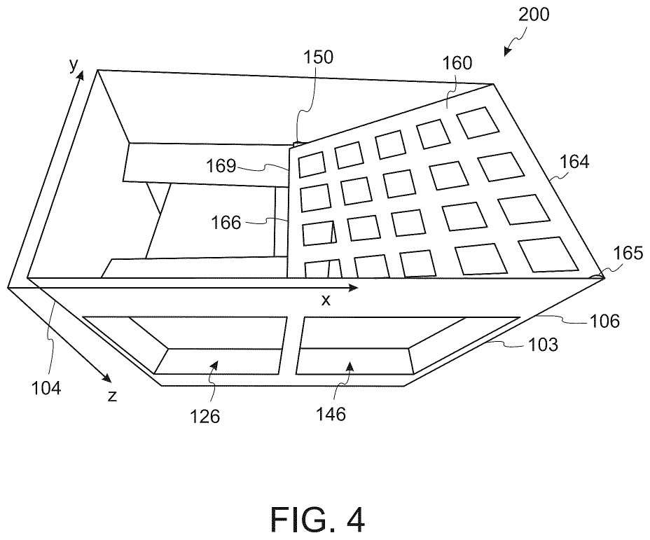

FIG. 4 depicts an embodiment of a waste receptacle 200. The waste receptacle 200 is similar to the waste receptacle 100 shown in FIGS. 1-3. Accordingly, like numbers will be used to refer to like features. For example, the waste receptacle 200 may include a grate 160 extending from an upper edge 164 to a lower edge 166.

As depicted in FIG. 4, the upper edge 164 may be coupled to the second sidewall 106. In particular, the upper edge 164 may have a hook 165 or a lip which may fit against the second sidewall 106. The lower edge 166 may be coupled to the divider 150. In particular, the lower edge 166 may have a hook 169 or a lip which may be fit against the divider 150. Accordingly, the lower edge 166 may be removably coupled to the divider 150. In other embodiments, the lower edge 166 may be nonremovably coupled to the divider 150, such as with weld, adhesive, screws, rivets, or other attachment means. In some embodiments, the lower edge 166 may be nonremovably coupled to the divider 150 with a hinge (not depicted). This may enable rotational movement of the grate 160 such that the grate 160 may be rotated away from the waste bin chamber 146 and toward the reuse bin chamber 126. Such rotation may allow increased access to the waste bin chamber 146.

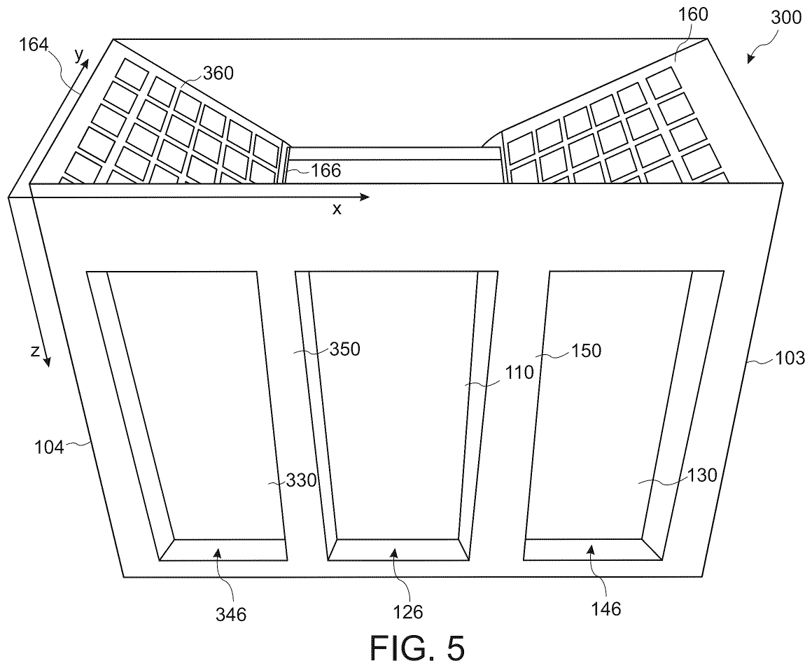

FIG. 5 depicts an embodiment of a waste receptacle 300. The waste receptacle 300 is similar to the waste receptacle 100 of FIGS. 1-3 and the waste receptacle 200 of FIG. 4. Accordingly, like numbers will be used to refer to like features.

As depicted in FIG. 5, the waste receptacle 300 may include one or more sidewalls 103 that define a waste bin chamber 146 (now referred to as a first waste bin chamber 146), a second waste bin chamber 346, and a reuse bin chamber 126 disposed between the first waste bin chamber 146 and the second waste bin chamber 346. The first waste bin chamber 146 may be sized to receive a waste bin 130 (now referred to as a first waste bin 130), the second waste bin chamber 346 may be sized to receive a second waste bin 330, and the reuse bin chamber 126 may be sized to receive a reuse bin 110. As depicted, in some embodiments, each of the first waste bin chamber 146, the second waste bin chamber 346, and the reuse bin chamber 126 may be substantially the same size. However, in other embodiments the sizes of the first waste bin chamber 146, the second waste bin chamber 346, and the reuse bin chamber 126 may vary.

The waste receptacle 300 may include a grate 160 (now referred to as a first grate 160) positioned above the first waste bin chamber 146 such as described with reference to the waste receptacle 100 depicted in FIGS. 1 and 2. The waste receptacle 300 may include a second grate 360 positioned above the second waste bin chamber 346. The second grate 360 may be substantially similar to the first grate 160. The second grate 360 may extend from a upper edge 164 coupled to the first sidewall 104 to a lower edge 166 coupled to a second divider 350. Accordingly, the second grate 360 may oriented at a downward angle with respect to the x-y plane as defined by the coordinate axis such that the second grate 360 slopes downward toward the reuse bin 110.

As will now be appreciated, in light of FIG. 5, the waste receptacle 300 may be configured to sort waste material from reuse material. In particular, a user wishing to discard a combination of reuse material and waste material (such as a recyclable paper plate laden with food scraps) may place the combination onto either onto the first grate 160 or the second grate 360. The waste material (e.g. the food scraps) may then drop into the associated waste bin 130, 330. The reuse material (e.g. the plate) may slide down the downward slope of the applicable grate 160, 360 and into the reuse bin 110. Accordingly, the waste material may be sorted into the waste bins 130, 330, and the reuse material may be sorted into the reuse bin 110. In this way, the waste receptacle 300 may sort waste material from reuse material.

Moreover, the waste receptacle 300 enables a user to approach and use the waste receptacle 300 from either side (e.g. near the first sidewall 104 or the second sidewall 106). This may be beneficial in some embodiments as it may enable multiple users to use the waste receptacle 300 contemporaneously. For example, a first user may approach the first sidewall 104 of the waste receptacle 300 and may discard a combination of reuse material and waste material onto the second grate 360. At the same time, a second user may approach the second sidewall 106 of the waste receptacle 300 and may discard a combination of reuse material and waste material onto the first grate 160. This may increase the volume of sorting achievable by the waste receptacle 300.

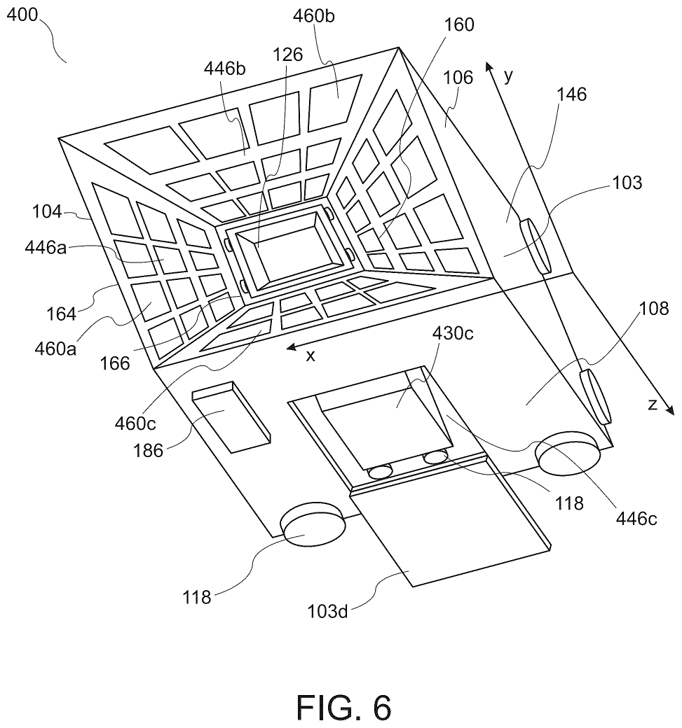

FIG. 6 depicts an embodiment of a waste receptacle 400. The waste receptacle 400 is similar to the waste receptacle 100 of FIGS. 1-3, the waste receptacle 200 of FIG. 4, and the waste receptacle 300 of FIG. 5. Accordingly, like numbers will be used to refer to like features.

As depicted in FIG. 6, the waste receptacle 400 may include one or more sidewalls 103 that define a first waste bin chamber 146, a second waste bin chamber, a third waste bin chamber, a fourth waste bin chamber, and a reuse bin chamber 126 disposed central to the waste bin chambers. The first waste bin chamber 146 may be sized to receive a first waste bin 130. The second waste bin chamber (not shown) may be sized to receive a second waste bin (not shown). The third waste bin chamber (not shown) may be sized to receive a third waste bin (not shown). The fourth waste bin chamber (not shown) may be sized to receive a fourth waste bin (not shown). The reuse bin chamber 126 may be sized to receive a reuse bin 110. As depicted, in some embodiments, each of the first waste bin chamber 146, the second waste bin chamber, the third waste bin chamber, the fourth waste bin chamber, and the reuse bin chamber 126 may be substantially the same size. However, in other embodiments the sizes of the first waste bin chamber 146, the second waste bin chamber, the third waste bin chamber, and the fourth waste bin chamber, and the reuse bin chamber 126 may vary. FIG. 6 further depicts an embodiment in which a chamber door 103d allows a user access to the waste bin and recycle bin chambers.

The waste receptacle 400 may include a first grate 160 positioned above the first waste bin chamber 146 such as described with reference to the waste receptacle 100 depicted in FIGS. 1 and 2. The waste receptacle 400 may include a second grate 460a positioned above the second waste bin chamber 446a. The second grate 460a may be substantially similar to the first grate 160. The second grate 460a may extend from an upper edge 164 coupled to the first sidewall 104 to a lower edge 166 coupled to a second divider 450a. Accordingly, the second grate 460a may oriented at a downward angle with respect to the x-y plane as defined by the coordinate axis such that the second grate 460a slopes downward toward the reuse bin 110. The waste receptacle 400 may include a third grate 460b positioned above the third waste bin chamber 446b. The third grate 460b may be substantially similar to the first grate 160. The third grate 460b may extend from a upper edge 164 coupled to the fourth sidewall 104 to a lower edge 166 coupled to a third divider 450b. Accordingly, the third grate 460b may oriented at a downward angle with respect to the x-y plane as defined by the coordinate axis such that the third grate 460b slopes downward toward the reuse bin 110. The waste receptacle 400 may include a fourth grate 460c positioned above the fourth waste bin chamber 446b. The fourth grate 460c may be substantially similar to the first grate 160. The fourth grate 460c may extend from a upper edge 164 coupled to the third sidewall 108 to a lower edge 166 coupled to a fourth divider 450c. Accordingly, the fourth grate 460c may oriented at a downward angle with respect to the x-y plane as defined by the coordinate axis such that the fourth grate 460c slopes downward toward the reuse bin 110.

As will now be appreciated, in light of FIG. 6, the waste receptacle 400 may be configured to sort waste material from reuse material. In particular, a user wishing to discard a combination of reuse material and waste material (such as a recyclable paper plate laden with food scraps) may place the combination onto any one of the first grate 160, the second grate 460a, the third grate 460b, or the fourth grate 460c. The waste material (e.g. the food scraps) may then drop into the associated waste bin 130, 430a, 430b, 430c. The reuse material (e.g. the plate) may slide down the downward slope of the applicable grate 160, 460a, 460b, 460c and into the reuse bin 110. Accordingly, the waste material may be sorted into the waste bins 130, 430a, 430b, 430c, and the reuse material may be sorted into the reuse bin 110. In this way, the waste receptacle 400 may sort waste material from reuse material.

Moreover, the waste receptacle 400 enables a user to approach and use the waste receptacle 400 from any side (e.g. near the first sidewall 104 or the second sidewall 106 or the fourth sidewall 109 or the third sidewall 108). This may be beneficial in some embodiments as it may enable multiple users to use the waste receptacle 400 contemporaneously. For example, a first user may approach the first sidewall 104 of the waste receptacle 400 and may discard a combination of reuse material and waste material onto the second grate 460a. At the same time, a second user may approach the second sidewall 106 of the waste receptacle 400 and may discard a combination of reuse material and waste material onto the first grate 160. At the same time, a third user may approach the fourth sidewall 109 of the waste receptacle 400 and may discard a combination of reuse material and waste material onto the third grate 460b. At the same time, a fourth user may approach the third sidewall 108 of the waste receptacle 400 and may discard a combination of reuse material and waste material onto the fourth grate 460c. This may increase the volume of sorting achievable by the waste receptacle 400.

As will now be appreciated, in light of FIG. 1 through FIG. 6, the reuse bin may be central to any number of geometries of surrounding waste receptacle.

From the above, it is to be appreciated that defined herein is a waste receptacle that includes a body and a grate. The body includes one or more sidewalls and one or more slats. The one or more sidewalls define a reuse bin chamber and a waste bin chamber, wherein the reuse bin chamber is sized to receive a reuse bin, and the waste bin chamber is sized to receive a waste bin. The one or more slats extending from the one or more sidewalls and disposed above the reuse bin chamber and the waste bin chamber. The grate is positioned above the waste bin chamber and extends from a lower edge to an upper edge, wherein the lower edge is coupled to the one or more slats, and the upper edge is coupled to the one or more sidewalls. Reuse material (e.g. plates, cutlery, and the like) separated by waste material by the grate or grates may be routed to a reuse bin, as facilitated by the slats, which waste material passing through the grate or grates may route to the waste bin. The angle of the grate facilitates movement of the reuse material to the reuse bin.

In some embodiments, the waste body may be larger than the reuse body. In some embodiments, the reuse body may be larger than the waste body. In some embodiments, the waste body may be the same size as the waste body. In some embodiments, the openings further comprise one or more doors. In some embodiments, the waste body may comprise one or more handles. In some embodiments, the waste bins may comprise one or more handles. In some embodiments, the reuse bin may comprise one or more handles.

In some embodiments, the ratio of the width of the waste receptacle to the length of the waste receptacle may be from 1:2 to 7:1. For instance, the ratio of the width to length (W:L) of the waste receptacle may be from 1:2 to 7:1, from 1:2 to 6:1, from 1:2 to 4:1, from 1:2 to 3:1, from 1:1 to 7:1, from 1:1 to 6:1, from 1:1 to 5:1, from 1:1 to 4:1, from 1:1 to 2:1, from 2:1 to 7:1, from 2:1 to 6:1, from 2:1 to 4:1, from 2:1 to 3:1, from 3:1 to 7:1, from 3:1 to 6:1, from 3:1 to 4:1, from 4:1 to 7:1, from 4:1 to 6:1, or from 6:1 to 7:1.

In some embodiments, the ratio of the height of the waste receptacle to the length of the waste receptacle may be from 1:4 to 4:1. For instance the ratio of the length to height (L:H) of the waste receptacle may be from 1:4 to 4:1, from 1:4 to 3:1, from 1:4 to 2:1, from 1:4 to 1:1, from 1:2 to 4:1, from 1:2 to 3:1, from 1:2 to 2:1, from 1:2 to 1:1, from 1:1 to 4:1, from 1:1 to 3:1, from 1:1 to 2:1, from 2:1 to 4:1, from 2:1 to 3:1, from 2:1 to 4:1, from 2:1 to 3:1, or from 3:1 to 4:1.

In some embodiments, the ratio of the volume of a waste bin to the volume of a reuse bin may be from 1:64 to 64:1. For example, the ratio of the volume of a waste bin to the volume of a reuse bin may be from 1:1 to 64:1, from 1:1 to 51:1, from 1:1 to 39:1, from 1:1 to 26:1, from 1:1 to 14:1, from 14:1 to 64:1, from 14:1 to 51:1, from 14:1 to 39:1, from 14:1 to 26:1, from 26:1 to 64:1, from 26:1 to 51:1, from 26:1 to 39:1, from 39:1 to 64:1, from 39:1 to 51:1, from 51:1 to 64:1, 1:64 to 1:1, from 1:64 to 51:64, from 1:64 to 39:64, from 1:64 to 26:64, from 1:64 to 14:64, from 14:64 to 64:64, from 14:64 to 51:64, from 14:64 to 39:64, from 14:64 to 26:64, from 26:64 to 64:64, from 26:64 to 51:64, from 26:64 to 39:64, from 39:64 to 64:64, from 39:64 to 51:64, or from 51:64 to 1:1.

In some embodiments, the width of the waste receptacle may be from 10 inches to 45 inches. For example, the width of the waste receptacle may be from 10 inches to 45 inches, from 10 inches to 38 inches, from 10 inches to 31 inches, from 10 inches to 24 inches, from 10 inches to 17 inches, from 17 inches to 45 inches, from 17 inches to 38 inches, from 17 inches to 31 inches, from 17 inches to 24 inches, from 24 inches to 45 inches, from 24 inches to 38 inches, from 24 inches to 31 inches, from 31 inches to 45 inches, from 31 inches to 38 inches, or from 38 inches to 45 inches.

In some embodiments, the length of the waste receptacle may be from 25 inches to 100 inches. For example, the length of the waste receptacle may be from 25 inches to 100 inches, from 25 inches to 85 inches, from 25 inches to 70 inches, from 25 inches to 55 inches, from 25 inches to 40 inches, from 40 inches to 100 inches, from 40 inches to 85 inches, from 40 inches to 70 inches, from 40 inches to 55 inches, from 55 inches to 100 inches, from 55 inches to 85 inches, from 55 inches to 70 inches, from 70 inches to 100 inches, from 70 inches to 85 inches, or from 85 inches to 100 inches.

In some embodiments, the height of the waste receptacle may be from 20 inches to 50 inches. For example, the height of the waste receptacle may be from 20 inches to 50 inches, from 20 inches to 45 inches, from 20 inches to 40 inches, from 20 inches to 35 inches, from 20 inches to 30 inches, from 20 inches to 25 inches, from 25 inches to 50 inches, from 25 inches to 45 inches, from 25 inches to 40 inches, from 25 inches to 35 inches, from 25 inches to 30 inches, from 30 inches to 50 inches, from 30 inches to 45 inches, from 30 inches to 40 inches, from 30 inches to 35 inches, from 35 inches to 50 inches, from 35 inches to 45 inches, from 35 inches to 40 inches, from 40 inches to 50 inches, from 40 inches to 45 inches, or from 45 inches to 50 inches.

In some embodiments, the width of the waste bin may be from 5 inches to 35 inches. For example, the width of the waste bin may be from 5 inches to 35 inches, from 5 inches to 30 inches, from 5 inches to 25 inches, from 5 inches to 20 inches, from 5 inches to 15 inches, from 5 inches to 10 inches, from 10 inches to 35 inches, from 10 inches to 30 inches, from 10 inches to 25 inches, from 10 inches to 20 inches, from 10 inches to 15 inches, from 15 inches to 35 inches, from 15 inches to 30 inches, from 15 inches to 25 inches, from 15 inches to 20 inches, from 20 inches to 35 inches, from 20 inches to 30 inches, from 20 inches to 25 inches, from 25 inches to 35 inches, from 25 inches to 30 inches, or from 30 inches to 35 inches.

In some embodiments, the length of the waste bin may be from 5 inches to 75 inches. For example, the length of the waste bin may be from 5 inches to 75 inches, from 5 inches to 65 inches, from 5 inches to 55 inches, from 5 inches to 45 inches, from 5 inches to 35 inches, from 5 inches to 25 inches, from 5 inches to 15 inches, from 15 inches to 75 inches, from 15 inches to 65 inches, from 15 inches to 55 inches, from 15 inches to 45 inches, from 15 inches to 35 inches, from 15 inches to 25 inches, from 25 inches to 75 inches, from 25 inches to 65 inches, from 25 inches to 55 inches, from 25 inches to 45 inches, from 25 inches to 35 inches, from 35 inches to 75 inches, from 35 inches to 65 inches, from 35 inches to 55 inches, from 35 inches to 45 inches, from 45 inches to 75 inches, from 45 inches to 65 inches, from 45 inches to 55 inches, from 55 inches to 75 inches, from 55 inches to 65 inches, or from 65 inches to 75 inches,

In some embodiments, the height of the waste bin may be from 10 inches to 50 inches. For example, the height of the waste bin may be from 10 inches to 50 inches, from 10 inches to 45 inches, from 10 inches to 40 inches, from 10 inches to 35 inches, from 10 inches to 30 inches, from 10 inches to 25 inches, from 10 inches to 20 inches, from 10 inches to 15 inches, from 15 inches to 50 inches, from 15 inches to 45 inches, from 15 inches to 40 inches, from 15 inches to 35 inches, from 15 inches to 30 inches, from 15 inches to 25 inches, from 15 inches to 20 inches, from 20 inches to 50 inches, from 20 inches to 45 inches, from 20 inches to 40 inches, from 20 inches to 35 inches, from 20 inches to 30 inches, from 20 inches to 25 inches, from 25 inches to 50 inches, from 25 inches to 45 inches, from 25 inches to 40 inches, from 25 inches to 35 inches, from 25 inches to 30 inches, from 30 inches to 50 inches, from 30 inches to 45 inches, from 30 inches to 40 inches, from 30 inches to 35 inches, from 35 inches to 50 inches, from 35 inches to 45 inches, from 35 inches to 40 inches, from 40 inches to 50 inches, from 40 inches to 45 inches, or from 45 inches to 50 inches.

In some embodiments, the width of the reuse bin may be from 5 inches to 35 inches. For example, the width of the reuse bin may be from 5 inches to 35 inches, from 5 inches to 30 inches, from 5 inches to 25 inches, from 5 inches to 20 inches, from 5 inches to 15 inches, from 5 inches to 10 inches, from 10 inches to 35 inches, from 10 inches to 30 inches, from 10 inches to 25 inches, from 10 inches to 20 inches, from 10 inches to 15 inches, from 15 inches to 35 inches, from 15 inches to 30 inches, from 15 inches to 25 inches, from 15 inches to 20 inches, from 20 inches to 35 inches, from 20 inches to 30 inches, from 20 inches to 25 inches, from 25 inches to 35 inches, from 25 inches to 30 inches, or from 30 inches to 35 inches.

In some embodiments, the length of the reuse bin may be from 5 inches to 75 inches. For example, the length of the reuse bin may be from 5 inches to 75 inches, from 5 inches to 65 inches, from 5 inches to 55 inches, from 5 inches to 45 inches, from 5 inches to 35 inches, from 5 inches to 25 inches, from 5 inches to 15 inches, from 15 inches to 75 inches, from 15 inches to 65 inches, from 15 inches to 55 inches, from 15 inches to 45 inches, from 15 inches to 35 inches, from 15 inches to 25 inches, from 25 inches to 75 inches, from 25 inches to 65 inches, from 25 inches to 55 inches, from 25 inches to 45 inches, from 25 inches to 35 inches, from 35 inches to 75 inches, from 35 inches to 65 inches, from 35 inches to 55 inches, from 35 inches to 45 inches, from 45 inches to 75 inches, from 45 inches to 65 inches, from 45 inches to 55 inches, from 55 inches to 75 inches, from 55 inches to 65 inches, or from 65 inches to 75 inches,

In some embodiments, the height of the reuse bin may be from 10 inches to 50 inches. For example, the height of the reuse bin may be from 10 inches to 50 inches, from 10 inches to 45 inches, from 10 inches to 40 inches, from 10 inches to 35 inches, from 10 inches to 30 inches, from 10 inches to 25 inches, from 10 inches to 20 inches, from 10 inches to 15 inches, from 15 inches to 50 inches, from 15 inches to 45 inches, from 15 inches to 40 inches, from 15 inches to 35 inches, from 15 inches to 30 inches, from 15 inches to 25 inches, from 15 inches to 20 inches, from 20 inches to 50 inches, from 20 inches to 45 inches, from 20 inches to 40 inches, from 20 inches to 35 inches, from 20 inches to 30 inches, from 20 inches to 25 inches, from 25 inches to 50 inches, from 25 inches to 45 inches, from 25 inches to 40 inches, from 25 inches to 35 inches, from 25 inches to 30 inches, from 30 inches to 50 inches, from 30 inches to 45 inches, from 30 inches to 40 inches, from 30 inches to 35 inches, from 35 inches to 50 inches, from 35 inches to 45 inches, from 35 inches to 40 inches, from 40 inches to 50 inches, from 40 inches to 45 inches, or from 45 inches to 50 inches.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed is:

1. A waste receptacle comprising a body and a grate, the body comprising:
one or more sidewalls defining a reuse bin chamber and a waste bin chamber, wherein the reuse bin chamber is sized to receive a reuse bin, and the waste bin chamber is sized to receive a waste bin; and
one or more slats extending from the one or more sidewalls and disposed above the reuse bin chamber and the waste bin chamber,
wherein the grate is positioned above the waste bin chamber and extends from a lower edge to an upper edge, wherein the lower edge is coupled to the one or more slats, and the upper edge is coupled to the one or more sidewalls.

2. The waste receptacle of claim 1, further comprising one or more pockets, the pockets removably attachable to one or more sidewalls.

3. The waste receptacle of claim 1, wherein the body comprises a lid, the waste bin comprises a lid, and the reuse bin comprises a lid.

4. The waste receptacle of claim 1, wherein the upper edge comprises a lip, wherein the lip is removably attached to top surface of one of the one or more sidewalls.

5. The waste receptacle of claim 1, further comprising a standoff, wherein the standoff is removably insertable between a top edge of the grate and the one or more sidewalls; and
the standoff is adjustable at an angle of the grate from 10 to 85 degrees.

6. The waste receptacle of claim 5, wherein the standoff further comprises a first hook at a first end and a second hook at a second end opposite the first end, wherein the second hook fits against the top surface of the one or more sidewalls and the first hook fits against the grate.

7. The waste receptacle of claim 1, wherein the lower edge comprises an extension, the one or more slats comprises an extension slot, and the lower edge is removably coupled to the one or more slats by inserting the lower edge extension into the extension slot of the one or more slats.

8. The waste receptacle of claim 1, wherein the one or more slats is formed with the body or attached thereto using weld, adhesive, screws, rivets, or combinations thereof.

9. The waste receptacle of claim 1, wherein
the body comprises one or more wheels disposed on a bottom surface of the body,
the waste bin further comprises one or more wheels disposed on a bottom surface of the waste bin; and
the reuse bin further comprises one or more wheels disposed on a bottom surface of the reuse bin.

10. The waste receptacle of claim 9, wherein the one or more wheels further comprise a wheel lock, the wheel lock moveable between a locked arrangement and an unlocked arrangement.

11. The waste receptacle of claim 1, wherein the reuse bin chamber and the waste bin chamber are spaced apart by a divider and the divider is substantially parallel to one or more of the one or more sidewalls.

12. The waste receptacle of claim 11, wherein the divider extends between the third sidewall and the fourth sidewall.

13. The waste receptacle of claim 12, wherein the divider extends to the third sidewall and to the fourth sidewall.

14. The waste receptacle of claim 1, wherein the grate comprises one or more apertures.

15. The waste receptacle of claim 14, wherein the one or more apertures have a shape resembling a square, a rectangle, a circle, an ellipse, any regular shape, any irregular shape, or combinations thereof.

16. The waste receptacle of claim 14, wherein the area of each of the one or more apertures is from 1 square inch to 8 square inch.

17. The waste receptacle of claim 1, wherein
the one or more sidewalls are perpendicular to a floor, the one or more sidewalls comprising:
a first sidewall;
a second sidewall spaced apart from the first sidewall;
a third sidewall extending between the first sidewall and the second sidewall; and
a fourth sidewall extending between the first sidewall and the second sidewall and opposite the third sidewall;
the one or more slats comprises a first slat and a second slat, each of the first slat and the second slat comprising a first elongated portion and a second elongated portion wherein the first slat extends from the third sidewall at a downward angle and the second slat extends from the fourth sidewall at a downward angle;
the grate is from 10 to 85 degrees relative to the floor.

18. The waste receptacle of claim 1, wherein the waste receptacle is circular in shape, and from 10 inches to 100 inches in diameter.

19. The waste receptacle of claim 1, further comprising an auxiliary bin coupled to the one or more sidewalls wherein the auxiliary bin comprises a body defining a pocket of from 9 cubic inches to 6500 cubic inches volume.

20. The waste receptacle of claim 19, wherein the auxiliary bin is removably coupled to the one or more sidewalls.

21. The waste receptacle of claim 1, further comprising one or more openings on the one or more sidewalls, to which a reuse bin or a waste bin may be passed through.
